(19) United States
(12) Patent Application Publication
(10) Pub. No.: US 2016/0042394 A1
(43) Pub. Date: Feb. 11, 2016

(54) AD EMBEDDED IN GALLERY

(71) Applicant: TangoMe, Inc., Mountain View, CA (US)

(72) Inventors: Xu Liu, San Jose, CA (US); Richard Rabbat, Palo Alto, CA (US); Eva Chau, Mountain View, CA (US); Paul Autran, Mountain View, CA (US)

(21) Appl. No.: 14/820,896

(22) Filed: Aug. 7, 2015

Related U.S. Application Data
(60) Provisional application No. 62/035,285, filed on Aug. 8, 2014.

(51) Int. Cl. G06Q 30/02; G06F 3/0484

(52) U.S. Cl. CPC G06Q 30/0257; G06F 3/04842

(57) ABSTRACT

A method for displaying ads on a communication device, the method includes: integrating a set of selectable ads within a group of selectable images that are enabled to be displayed on a display screen of the communication device; selectively displaying on the display screen a selectable ad of the set of selectable ads during a display of the group of selectable images; and enlarging the selectable ad upon receiving a selection via a first input.

### REFERENCE TO RELATED APPLICATIONS

This application claims priority to and the benefit of co-pending U.S. Patent Application No. 62/035,285 filed on Aug. 8, 2014 entitled “AD EMBEDDED IN GALLERY” by Liu et al., having Attorney Docket No. TNGO-035.PRO, and assigned to the assignee of the present application, and is hereby incorporated by reference in its entirety herein.

### BACKGROUND

Conventional technologies and methods for providing advertisements in web-based applications generally include banner and interstitial ads, which distract the user and impact the user's experience in a negative way.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram that illustrates an embodiment of an ad displayer, in accordance with an embodiment.

FIG. 2 is a block diagram that illustrates an embodiment of an ad displayer, in accordance with an embodiment.

FIG. 3 is a block diagram that illustrates a display screen having thereon in operation selectable ads embedded in a gallery of selectable images, in accordance with an embodiment.

FIG. 4 depicts a flow diagram for a method for displaying ads on a communication device, in accordance with an embodiment.

FIGS. 5-9 illustrate example display screen images during operation of one or more embodiments.

FIG. 10 is a block diagram of an example computer system with which or upon which various embodiments of the present invention may be implemented.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

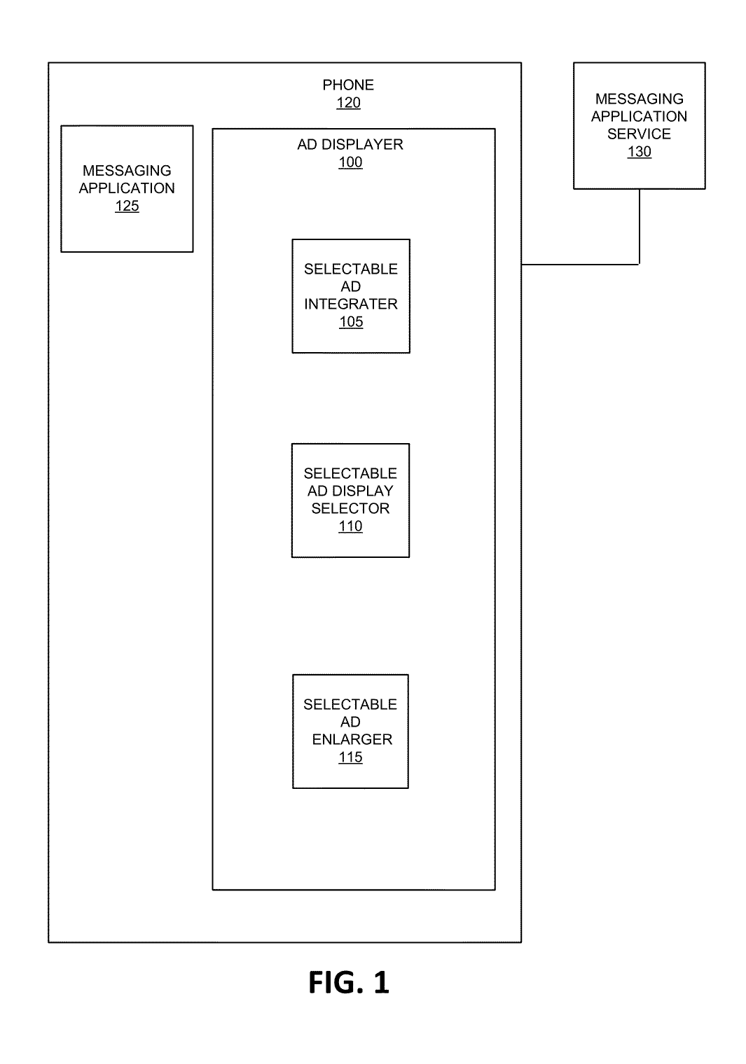

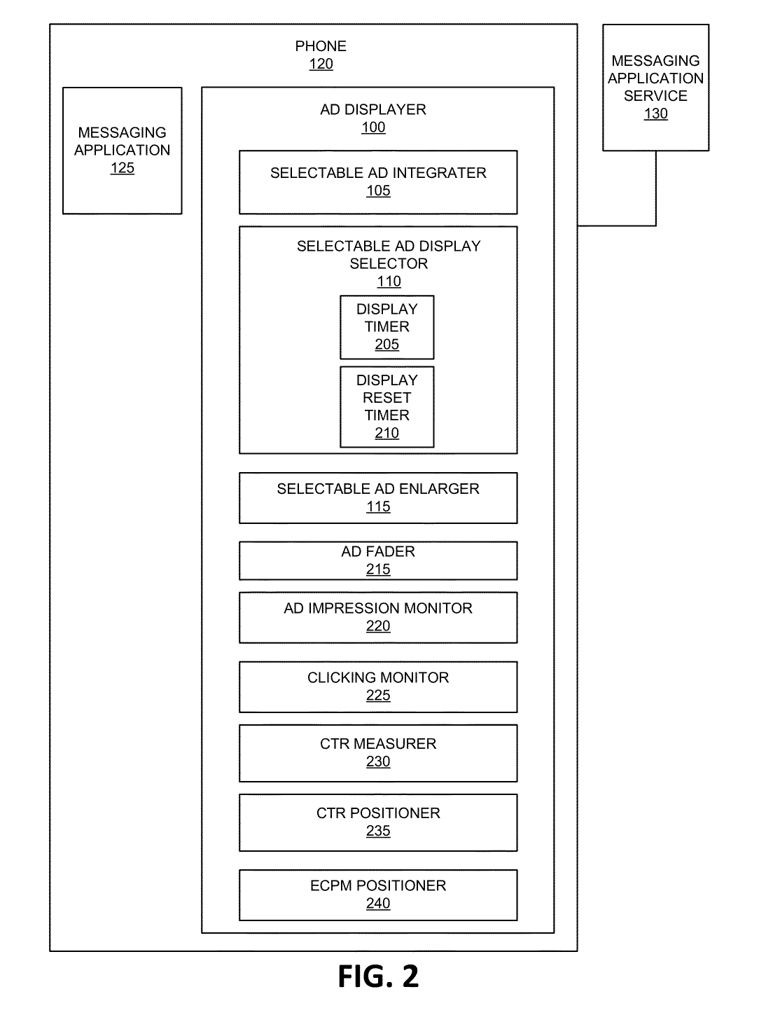

Unless specifically stated otherwise as apparent from the following discussions, it is appreciated that throughout the present Description of Embodiments, discussions utilizing terms and variation of such terms such as “integrates”, “displays”, “enlarges”, “fades”, “monitors”, “measures”, “positions”, or the like, often refer to the actions and processes of an electronic computing device (or portion thereof), module or system, such as, but not limited to, an ad displayer 100 (See FIGS. 1 and 2), unless noted otherwise. The electronic computing device/module/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### OVERVIEW OF EMBODIMENTS AND DISCUSSION

Conventional technologies and methods for providing advertisements (ad(s)) in web-based applications generally include banner and interstitial ads, which distract the user and impact the user's experience in a negative way.

Embodiments of the present technology provide a solution, via an ad displayer, for concurrently displaying ads and running application content that reduces and/or eliminates distracting banner and interstitial type ads while both helping to generate revenue for the company associated with the application and grow users of the application. More specifically, embodiments enable ads to be embedded within a gallery of images on display while maintaining the overall native user experience of perusing the gallery. In one embodiment, the application providing the gallery experience is running on a messaging application, for example, TANGO™. However, in another embodiment, the application providing the gallery experience is the messaging application.

One or more embodiments display an ad once every so many images that are displayed (in a slide swiping display configuration). An ad cannot be adjacent to another ad. In another embodiment, a user may click on an selectable image the enlarge the image view and the rest of the adjacent images are pushed to the background and fade in color. If an ad happens to be adjacent to the selected and enlarged image, then that ad will also be faded similar to the other faded images in the background. In yet another embodiment, when a user selects and enlarges an image to a full screen view and then swipes through the selectable images in the gallery, an ad will show every time after the user has swiped through a predetermined number of images in the gallery.

By providing these ads within a gallery display of selectable images, embodiments help generate revenue opportunities for both the messaging application and/or the provider of the application having the gallery of images. Additionally, highly targeted ads can be shown to the user based on the users' interests and channel content, which can yield greater user engagement.

In accordance with embodiments, the ad displayer 100 can reside at the messaging application installed on a mobile device or a server communicatively coupled with the messaging application. The ad displayer 100 functions to embed ads within a gallery, wherein the gallery may be part of another application also running on the messaging application (on the mobile device), on the server communicatively coupled with the messaging application and/or on the messaging application itself.

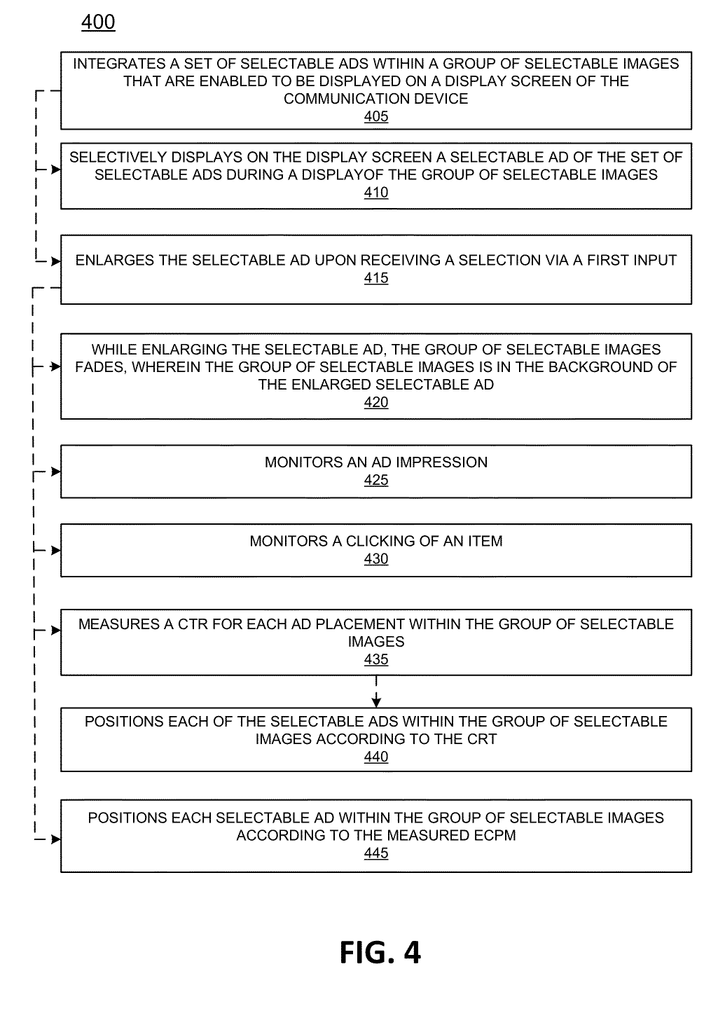

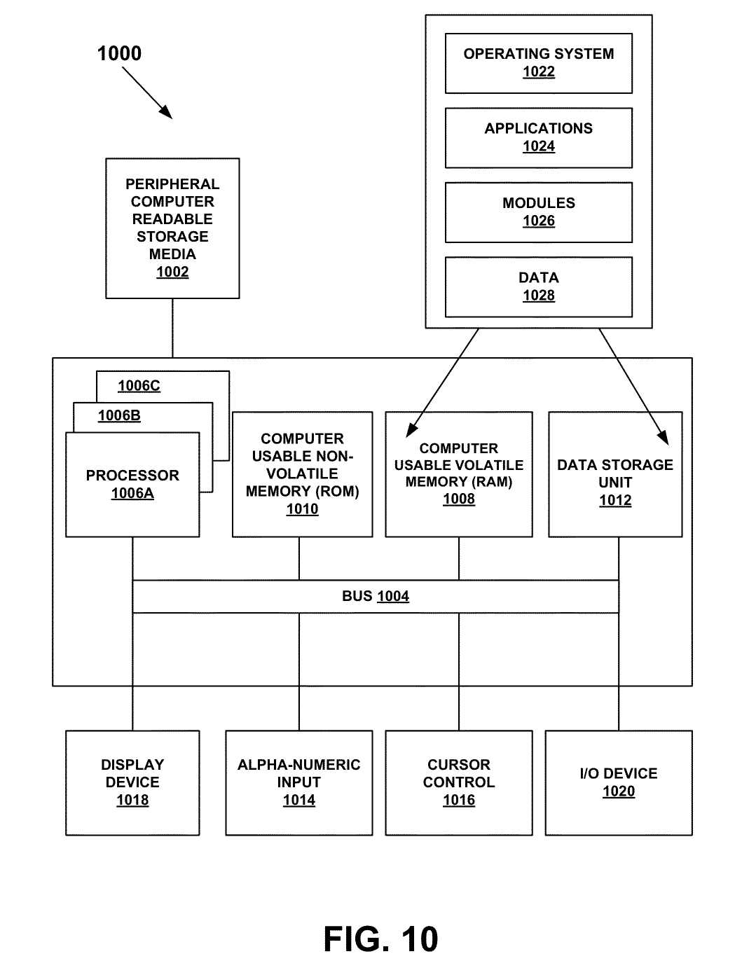

The following discussion will begin with a description of an ad displayer, with references to FIGS. 1-3. The discussion will follow with a description of a method of operation for displaying ads on a communication device, with reference to FIGS. 4-9. With reference to FIG. 10, the discussion concludes with a description of an example computer system with which or upon which various embodiments of the present technology may be implemented.

### Example Ad Displayer

FIGS. 1 and 2 depict block diagrams that illustrates an ad displayer 100 that includes the following modules coupled with a computer, such as computer 1000 of FIG. 10: a selectable ad integrater 105; an ad display selector 110; and a selectable ad enlarger 115. The ad display selector 110 optionally includes, in some or all embodiments, any of the following: a display timer 205; and a display reset timer 210. The ad displayer 100 optionally includes, in some or all embodiments, any of the following: an ad fader 215; ad impression monitor 220; clicking monitor 225; CTR measurer 230; CTR positioner 235; and eCPM positioner 240. In one embodiment, the ad displayer 100 resides at a communication device (e.g., mobile phone 120), is communicatively coupled with a messaging application 125, and/or resides at the messaging application service 130 (which supports the messaging application).

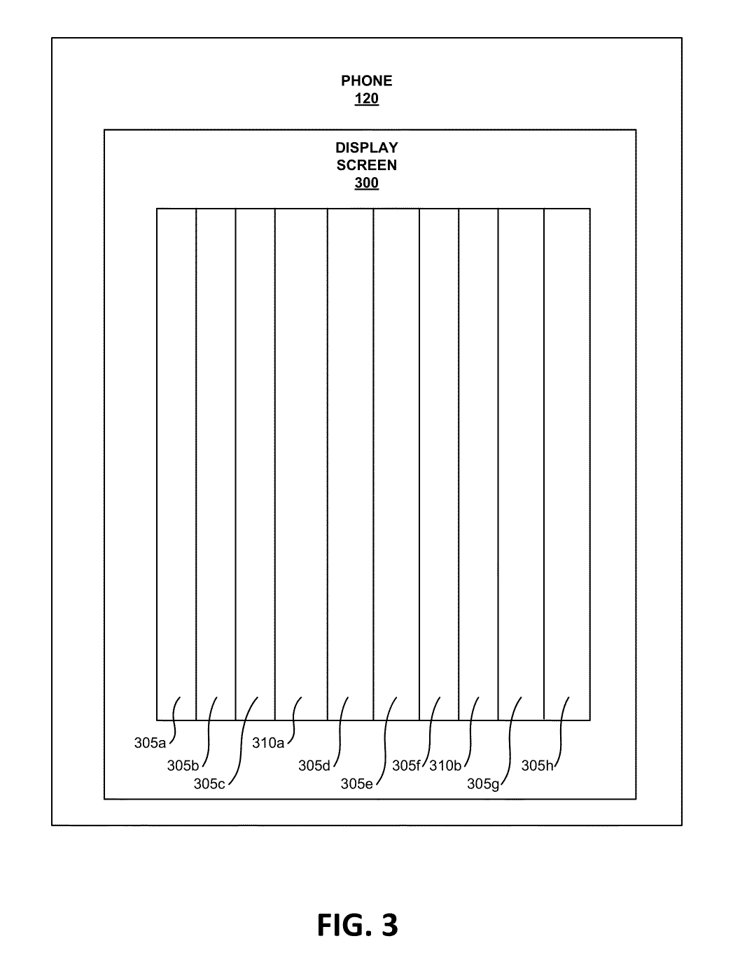

The ad displayer 100 will now be discussed, with reference to FIGS. 1-3. FIG. 3 is a block diagram that illustrates a display screen having thereon in operation selectable ads embedded in a gallery of selectable images, in accordance with an embodiment. The ad displayer 100 includes: the selectable ad integrater 105; the ad display selector 110; and the selectable ad enlarger 115.

The selectable ad integrator 105 is configured for integrating a set of selectable ads (e.g., set of selectable ads 310 includes at least selectable ads 310a and 310b) within a group of selectable images (e.g., set of selectable images 305 includes at least selectable images 305a, 305b, 305c, 305d, 305e, 305f, 305g, 305n . . . ) that are enabled to be displayed on a display screen 300 of the communication device, phone 120. It should be noted that the communication device may be any device that is enabled to communicate with other devices. (Of note, this includes devices other than phones). Additionally, in some or all embodiments, the communication device in some or all embodiments has installed thereon, and operating in conjunction with each other, the ad displayer 100 and a messaging application. This integration occurs according to a set of preconfigured rules. These preconfigured rules may include instructions for the positioning of the selectable ads relative to other selectable ads within the gallery of selectable images, the size, shape, number of total ads, content and format of the selectable ads that may be embedded within the gallery of selectable images.

For example, in one embodiment, a preconfigured rule states that a selectable ad must contain a 100×100 icon, title, text, and a 640×334 image and the top of the selectable ad should read, “Sponsored”. Another rule might require that selectable ads to be placed in the gallery of selectable images must all be the same size. In one embodiment, the client (the provider of the selectable ad content) is required to crop its selectable ad to accommodate these preconfigured rules. In one embodiment, the preconfigured rules state that the design configuration of the selectable ads must be the same as the selectable ads shown in the messaging application news feed. By selectable advertisement, for example, it is meant to include ads which are presented at the display screen, such as display screen 300, which may be selected by a user via any method known in the art for selecting content from a device having an input device (e.g., clicking, voice activated, pushing a button on the device, typing, etc.).

In one embodiment, the ad display selector 110 is configured for selectively displaying on the display screen 300 a selectable ad (e.g., 310a) of the set of selectable ads 310 during a display of the group of selectable images 305. For example, in various embodiments, the ad display selector 110 displays one or more selectable ad according to a timing schedule. This timing schedule may include an actual time or measure display time in terms of quantity of selectable images displayed, as will be described as follows. In some or all embodiments, the ad display selector 100 includes any of the following: a display timer 205; and a display reset timer 210. The display timer 205 is configured for displaying a sequence of selectable ads, wherein each selectable ad of the sequence of selectable ads is not adjacent to each other, and wherein each selectable ad of the sequence of selectable ads is displayed after a predetermined number of images of the group of selectable images 305 is displayed. For example and with reference to FIG. 3, the sequence of selectable ads includes 310a and 310b. Selectable ads 310a and 310b are not adjacent to each other. There are three selectable images inbetween selectable ads 310a and 310b. For example, between selectable ads 310a and 310b are selectable images 305d, 305e and 305f. The display timer 205 displays the selectable ads 310a and 310b such that there are a predetermined number of images (three) of the group of selectable images 305 there between.

In one embodiment, the display reset timer 210 is configured for: displaying on the display screen a selectable ad after a swipe and a selection of a selectable image is performed on the communication device and a predetermined quantity of the group of the selectable images has passed. For example, a user may browse through the gallery of selectable images by swiping across the display screen 300. The user then selects a selectable image by touching the icon representing a selectable image, such as selectable image 305d. The selectable image 305d is enlarged. The user then decides to continue browsing the gallery of selectable images, and causes the selectable image 305d to return to its original and smaller size. The display reset timer 210 displays the second selectable ad (310b) in the sequence of selectable ads (310a, 310b) in accordance with preconfigured rules that state that after a selection of a selectable image, a selectable ad may not be displayed again until two more selectable images (e.g., selectable images 305e, 305f) are displayed. Thus, every time that a user selects a selectable image for viewing, the timing of the display of the selectable ads is reset such that the next selectable ad will only be displayed an exact number of images away from the placement of the selected selectable image (e.g., selectable image 305d). In another example, assume that there are ten selectable images in the gallery of images and a user clicks (selects) image number three. The user will not see another selectable ad until four swipes later. Thus, the next selectable ad will show up after selectable image number seven is displayed.

The selectable ad enlarger 115 is configured for enlarging the selectable ad upon receiving a selection of the selectable ad via a first input. For example, in response to receiving a selection of the selectable ad (e.g., 310b), the selectable enlarger 115 enlarges the chosen selectable ad 310b such that it appears larger on the display screen 300 that when it was selected.

The ad fader 215 is configured for while enlarging the selectable ad, fading the group of selectable images, wherein the group of selectable images is in the background of the enlarged selectable ad. For example, the ad fader 215, in response to a selection of a selectable ad (e.g., 310a), will fade the group of selectable images (e.g., 305b, 305c, 305d, 305e) that are concurrently being displayed on the display screen 300. This group of selectable images is displayed in the background of the enlarged selectable ad 310a on the display screen 300. In another embodiment, a selectable image (e.g., 305c) is selected and the surrounding selectable images and selectable ads (e.g., 305a, 305b, 310a, 305d) are faded into the background of the display screen. In one embodiment, the fading includes a color change. For example, a selectable ad that is faded into the background may be displayed originally with bright red. However, in one embodiment, during the fading action, the bright red color is turned into a gray. This gray color is much less noticeable and distracting, thereby helping the viewer of the display screen 300 to more easily see his/her selection choice. In another embodiment, the fading action causes a bright color to fade to be a lesser version of the original bright color. For example, before the fading of a selectable image, the selectable image was bright yellow. However, the fading causes the bright yellow to become a dull yellow, thereby helping the viewer of the display screen 300 to more easily see his/her selection choice.

The ad impression monitor 220 is configured to monitor an ad impression. For example, the ad impression monitor 220 tallies the number of times that a particular selectable ad is selected, thereby achieving a total “ad impression” count. Additionally, in one embodiment, the number of times that a particular selectable image is selected is also tallied by an image impression monitor. In one embodiment, an ad impression is considered to be viewable and can be tracked in the gallery when the selectable ad is shown for more than one second if greater than fifty percent of the selectable ad is showing.

The clicking monitor 225 is configured for monitoring a clicking of a selectable item predefined to be monitored.

The CTR measurer 230 is configured for measuring CTR for each ad placement within the group of selectable image. For example, the CTR (Click Through Rate) measurer 230 measures the CTR for the placement of each selectable ad within the group of selectable images 305. The CTR Positioner 235 is configured for positioning each selectable ad of the group of selectable images according to the measured CTR. For example, if the CTR is determined to be favorable for a particular set of selectable ads and/or selectable images, then the CTR positioner 235, may in one embodiment, position another selectable ad in close proximity to the position that was found to be favorable. Such as positioning may increase sales and therefore revenue.

The eCPM (effective Cost-Per-Mill) positioner 240 is configured for positioning each selectable ad within the group of selectable images according to a measured eCPM. For example, the eCPM rate is computed, wherein the eCPM rate may be collected from ad networks for each ad unit. The selectable ads may be organized in the gallery, in one embodiment, from the highest eCPM first to the lowest eCPM last.

The ad displayer 100 is communicatively coupled with the messaging application service 130 and a computer, such as the computer 1000 of FIG. 10. The processor of the computer 1000 is configured for, at least, performing the following processing steps: integrating a set of selectable ads within a group of selectable images that are enabled to be displayed on a display screen of the communication device; selectively displaying on the display screen a selectable ad of the set of selectable ads during a display of the group of selectable images; and enlarging at least one of the selectable ad and the selectable image upon receiving a selection via a first input.

### Example Methods of Operation

The following discussion sets forth in detail some example methods of operation of embodiments. With reference to FIGS. 4-9, a flow diagram of method 400 for displaying ads on a communication device is shown, in accordance with embodiments. Method 400 includes some procedures that, in various embodiments, are carried out by a processor under the control of computer-readable and computer-executable instructions. In various embodiments, these computer-readable and computer-executable instructions are described as “code segments”, and presented separately (e.g., first codes segment, second code segment, etc.) to describe such instructions. In this fashion, procedures described herein and in conjunction with these flow diagrams, alone or in combination, are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware).

The following discussion of method 400 references FIGS. 4-9 unless specifically noted otherwise.

At step 405 of method 400, in one embodiment and as described herein, a set of selectable ads is integrated within a group of selectable images that are enabled to be displayed on a display screen of said communication device.

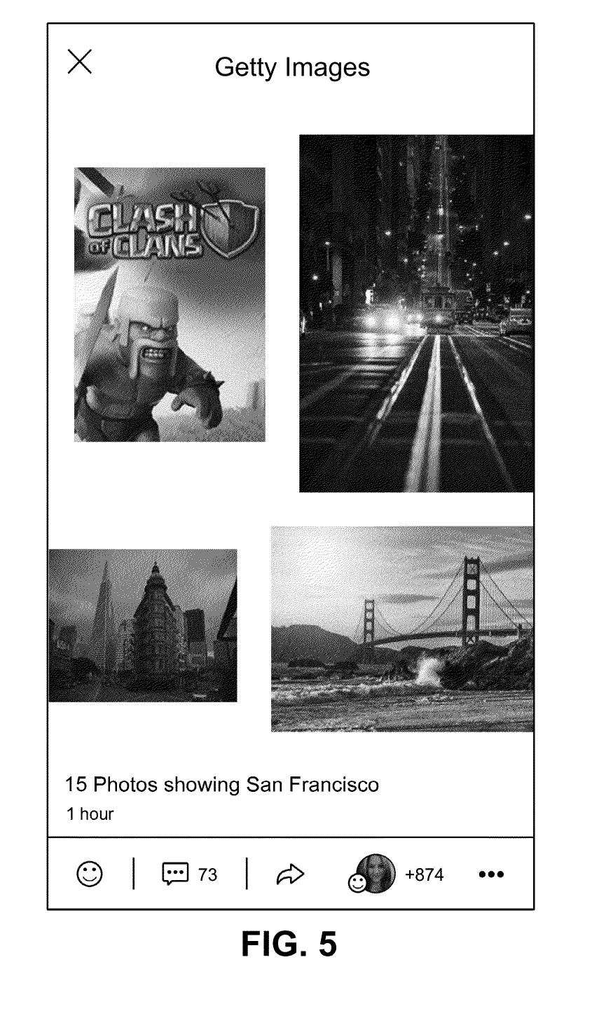

At step 410 of method 400, in one embodiment and as described herein, selectively displaying on said display screen a selectable ad of the set of selectable ads during a display of the group of selectable images. In one embodiment, a sequence of selectable ads is displaying, wherein each selectable ad of the sequence of selectable ads is not adjacent to each other, and wherein each selectable ad of the sequence of selectable ads is displayed after a predetermined number of images of the group of selectable images is displayed. In another embodiment, on the display screen, a selectable ad is displayed after a swipe is performed on the communication device and a predetermined quantity of the group of the selectable images has passed. FIG. 5 illustrates a group of three selectable images are displayed alongside one selectable ad (for “Clash of Clans” application). As can be seen, the selectable add is about the same size as the selectable images.

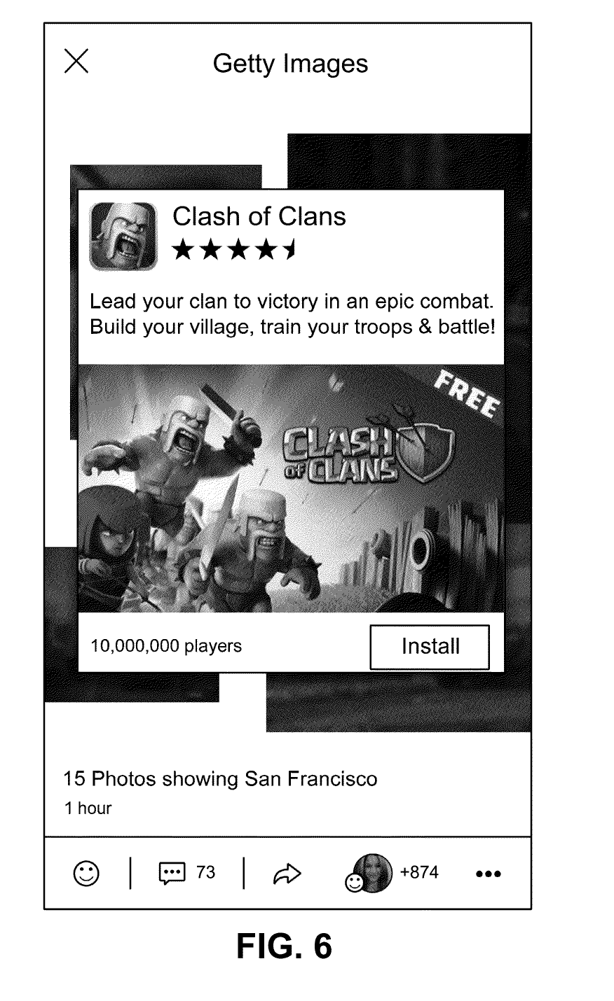

At step 415 of method 400, in one embodiment and as described herein, at the selectable ad is enlarged, upon receiving a selection via a first input. On note, the first input is an input received at an input module and/or device. For example, the clicking on an icon or the touching of an icon on a touch screen creates an input of information indicating that a selection has been made. FIG. 6 illustrates the selectable ad having been enlarged after the selectable ad (“Clash of Clans”) was selected. As can be seen, the enlarged item occupies a little over half of the display screen.

At step 420 of method 400, in one embodiment and as described herein, while enlarging the selectable ad, the group of selectable images fades, wherein the group of selectable images is in the background of the enlarged selectable ad. In one embodiment, a color fades to a less bright color and those objects with faded colors appear in the background of the image. In another embodiment, the color of objects that appear in the background of the selected and enlarged image is changed to a different color. With reference again to FIG. 6, it can be seen that all of the selectable images that were not chosen to be enlarged are shown to have “faded” into the background. The images of the selectable images in the background of the selected selectable ad appear to be blurry and faded.

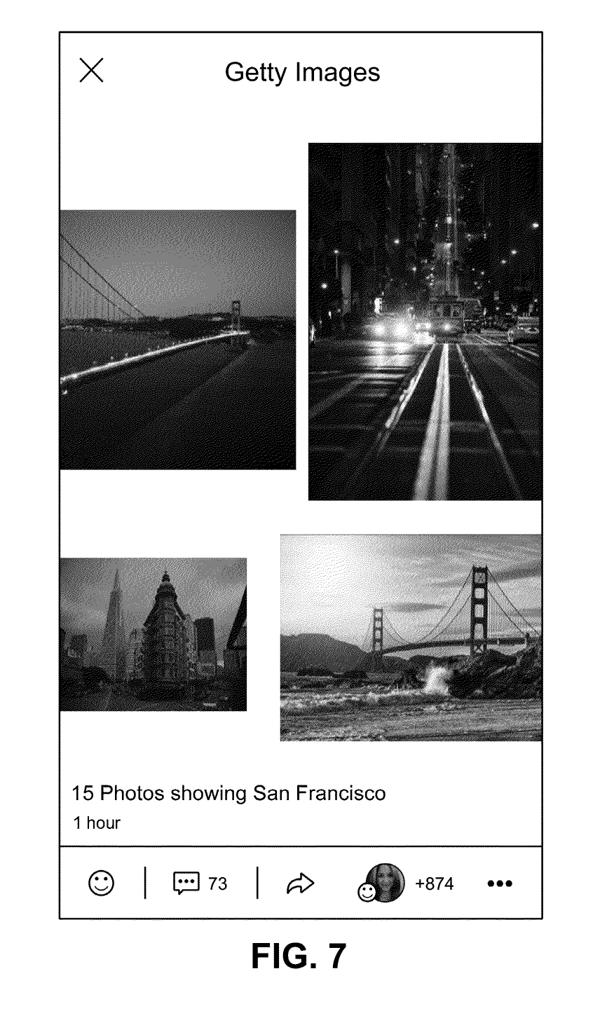

With reference to FIG. 7, after the user selected the “Clash of Clans” selectable image for enlargement and viewed the enlarged image, the user then selected (by touching the icon) the “Clash of Clans” again. Of note, the display screen shows selectable images from the gallery of images, and no longer shows the selectable ad (“Clash of Clans”). As already described herein, this is a situation in which once a selectable ad is selected, viewed, and then selected again to go back to the gallery of images, a new selectable ad in the sequence of selectable ads will not be viewable again until the predetermined number of selectable images are viewable on the display screen.

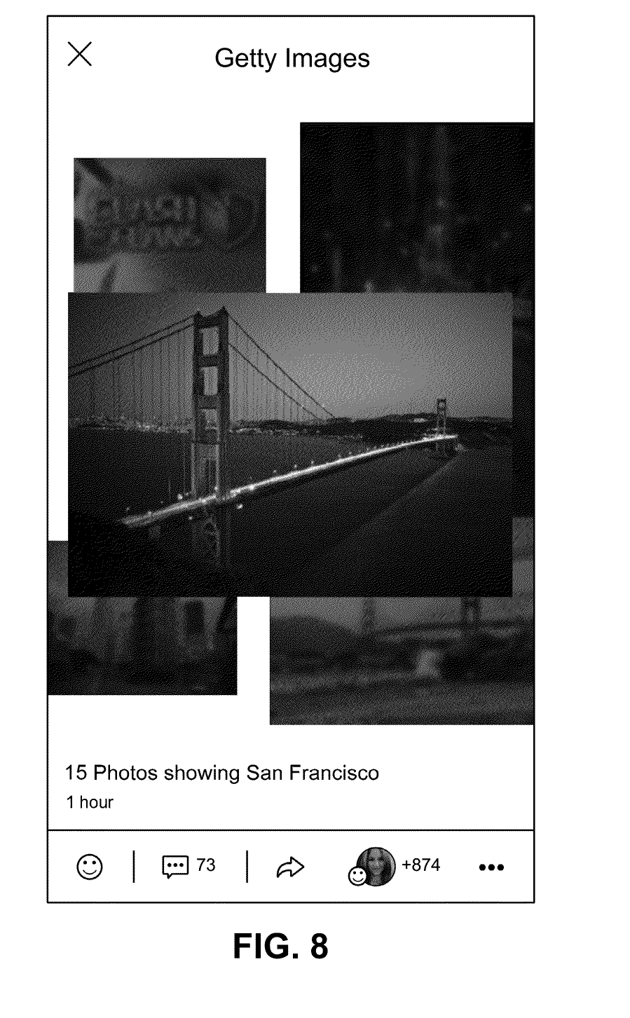

With reference now to FIG. 8, it is shown an instance in which after selecting the selectable image of a bridge, the enlarged image of the selectable image appeared, and the selectable images in the background has become faded, the user is unable to select the any of the faded selectable ads (e.g., “Clash of Clans”) to be brought to the location that allows for installing the application (if the faded selectable images are applications for installation). The selectable ad is only selectable if it appears unfaded. To “unfade” the selectable image, in one embodiment, the bridge is “clicked” on. By such a click, it is indicated that the bridge is to return to one of the several images showing on the display screen, where the “Clash of Clans” is one of a certain number of images.

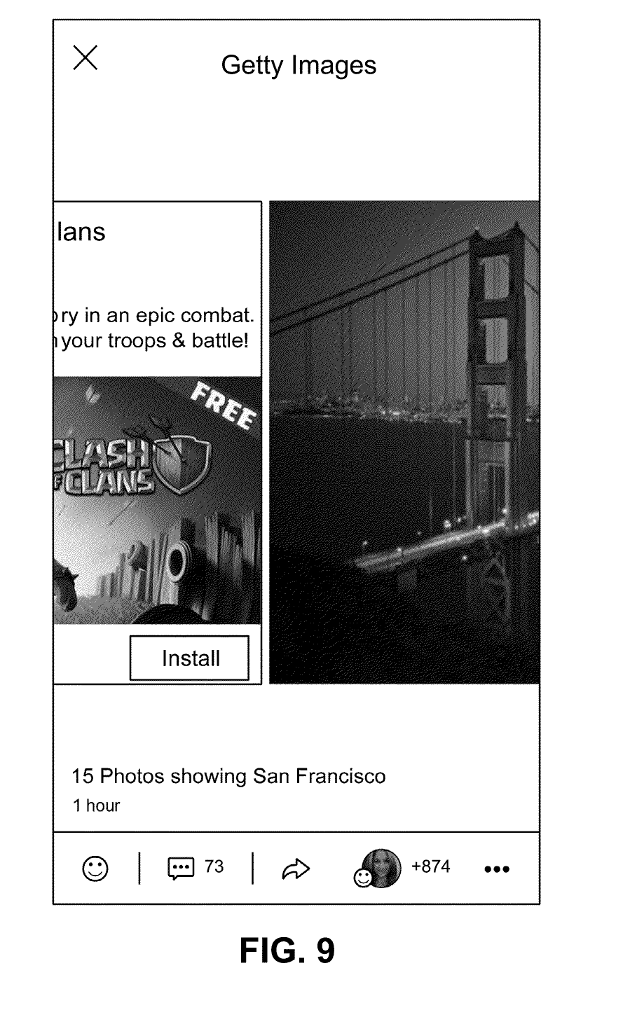

In one embodiment, images slide across the display screen, from one image to the next image. FIG. 9 shows a selectable ad and a selectable image sliding across the display screen. The images are caused to slide by the swiping motion of an input.

At 425 of method 400, in one embodiment and as described herein, an ad impression in monitored. At 430 of method 400, in one embodiment and as described herein, a clicking of an item is monitored.

At 435 of method 400, in one embodiment and as described herein, a CTR is measured for each ad placement within the group of selectable images. At 440 of method 400, in one embodiment and as described herein, each of the selectable ads within the group of selectable images is positioned according to the CRT. At 445 of method 400, in one embodiment and as described herein, each selectable ad within the group of selectable images is positioned according to the measured eCPM. The gallery of selectable images may make an anticipatory request that multiple ads at scroll time (of user) be displayed, and instructing that these selectable ads be displayed from the highest eCPM to the lowest eCPM.

One embodiment mixes ads from multiple ad networks, such that the revenue performance of an application may be increased. In another embodiment, If an selectable ad is experiencing negative targeting, then the selectable ad in question is not shown. In another embodiment, when a user clicks on the selectable ad and redirects to a landing page (i.e., google play, app store, etc.) regardless of whether the user clicked “install” or “cancel”, the user will be directed back to where he/she was left when attempting to go back to the messaging application.

### Example Computer System

With reference now to FIG. 10, all or portions of some embodiments described herein are composed of computer-readable and computer-executable instructions that reside, for example, in computer-usable/computer-readable storage media of a computer system. That is, FIG. 10 illustrates one example of a type of computer (computer system 1000) that can be used in accordance with or to implement various embodiments which are discussed herein. It is appreciated that computer system 1000 of FIG. 10 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems, multi-media devices, and the like. Computer system 1000 of FIG. 10 is well adapted to having peripheral non-transitory computer-readable storage media 1002 such as, for example, a floppy disk, a compact disc, digital versatile disc, other disc based storage, universal serial bus “thumb” drive, removable memory card, and the like coupled thereto.

System 1000 of FIG. 10 includes an address/data bus 1004 for communicating information, and a processor 1006A coupled with bus 1004 for processing information and instructions. As depicted in FIG. 10, system 1000 is also well suited to a multi-processor environment in which a plurality of processors 1006A, 10068, and 1006C are present. Conversely, system 1000 is also well suited to having a single processor such as, for example, processor 1006A. Processors 1006A, 1006B, and 1006C may be any of various types of microprocessors. System 1000 also includes data storage features such as a computer usable volatile memory 1008, e.g., random access memory (RAM), coupled with bus 1004 for storing information and instructions for processors 1006A, 1006B, and 1006C.

System 1000 also includes computer usable non-volatile memory 1010, e.g., read only memory (ROM), coupled with bus 804 for storing static information and instructions for processors 1006A, 10068, and 1006C. Also present in system 1000 is a data storage unit 1012 (e.g., a magnetic or optical disk and disk drive) coupled with bus 1004 for storing information and instructions. System 1000 also includes an optional alphanumeric input device 1014 including alphanumeric and function keys coupled with bus 1004 for communicating information and command selections to processor 1006A or processors 1006A, 10068, and 1006C. System 1000 also includes an optional cursor control device 1016 coupled with bus 1004 for communicating user input information and command selections to processor 1006A or processors 1006A, 1006B, and 1006C. In one embodiment, system 1000 also includes an optional display device 1018 coupled with bus 1004 for displaying information.

Referring still to FIG. 10, optional display device 1018 of FIG. 10 may be a liquid crystal device, cathode ray tube, plasma display device or other display device suitable for creating graphic images and alphanumeric characters recognizable to a user. Optional cursor control device 1116 allows the computer user to dynamically signal the movement of a visible symbol (cursor) on a display screen of display device 1018 and indicate user selections of selectable items displayed on display device 1018. Many implementations of cursor control device 1016 are known in the art including a trackball, mouse, touch pad, joystick or special keys on alphanumeric input device 1014 capable of signaling movement of a given direction or manner of displacement. Alternatively, it will be appreciated that a cursor can be directed and/or activated via input from alphanumeric input device 1014 using special keys and key sequence commands. System 1000 is also well suited to having a cursor directed by other means such as, for example, voice commands. System 1000 also includes an I/O device 1020 for coupling system 1000 with external entities. For example, in one embodiment, I/O device 1020 is a modem for enabling wired or wireless communications between system 1000 and an external network such as, but not limited to, the Internet.

Referring still to FIG. 10, various other components are depicted for system 1000. Specifically, when present, an operating system 1022, applications 1024, modules 1026, and data 1028 are shown as typically residing in one or some combination of computer usable volatile memory 1008 (e.g., RAM), computer usable non-volatile memory 1010 (e.g., ROM), and data storage unit 1012. In some embodiments, all or portions of various embodiments described herein are stored, for example, as an application 1024 and/or module 1026 in memory locations within RAM 808, computer-readable storage media within data storage unit 1012, peripheral computer-readable storage media 1002, and/or other tangible computer-readable storage media.

What we claim is:

1. An article of manufacture, which comprises a computer readable medium having stored therein a computer program for displaying ads on a communication device, said computer program comprising:
a first code segment which, when executed on a computer, integrates a set of selectable ads within a group of selectable images that are enabled to be displayed on a display screen of said communication device;
a second code segment which, when executed on said computer, selectively displaying on said display screen a selectable ad of said set of selectable ads during a display of said group of selectable images; and
a third code segment which, when executed on said computer, enlarges said selectable ad upon receiving a selection via a first input.

2. The article of manufacture of claim 1, wherein said second code segment comprises:
a fourth code segment which, when executed on said computer, displays a sequence of selectable ads, wherein each selectable ad of said sequence of selectable ads is not adjacent to each other, and wherein each selectable ad of said sequence of selectable ads is displayed after a predetermined number of images of said group of selectable images is displayed.

3. The article of manufacture of claim 1, further comprising:
a fifth code segment which, when executed on said computer, while enlarging said selectable ad, fades said group of selectable images, wherein said group of selectable images are in a background of said enlarged selectable ad.

4. The article of manufacture of claim 1, further comprising:
a sixth code segment which, when executed on said computer, displays on said display screen a selectable ad after a swipe is performed on said communication device and a predetermined quantity of said group of said selectable images has passed.

5. The article of manufacture of claim 4, wherein each selectable ad of said set of selectable ads is the same size as each other.

6. The article of manufacture of claim 1, further comprising:
a seventh code segment which, when executed on said computer, monitors an ad impression.

7. The article of manufacture of claim 1, further comprising:
n eighth code segment which, when executed on said computer, monitors a clicking of an item.

8. The article of manufacture of claim 1, further comprising:
a ninth code segment which, when executed on said computer, measures CTR for each ad placement within said group of selectable images.

9. The article of manufacture of claim 8, further comprising:
a tenth code segment which, when executed on said computer, positions each selectable ad within said group of selectable images according to measured CTR.

10. The article of manufacture of claim 1, further comprising:
an eleventh code segment which, when executed on said computer, positions each selectable ad within said group of selectable images according to a measured eCPM.

11. An ad displayer configured for displaying an ad on a display screen of a communication device, said ad displayer comprising:
a selectable ad integrater configured for a set of selectable ads within a group of selectable images that are enabled to be displayed on a display screen of said communication device;
a selectable ad display selector configured for selectively displaying on said display screen a selectable ad of said set of selectable ads during a display of said group of selectable images; and
a selectable ad enlarger configured for enlarging said selectable ad upon receiving a selection via a first input.

12. The ad displayer of claim 11, wherein said ad display selector comprises:
a display timer configured for displaying a sequence of selectable ads, wherein each selectable ad of said sequence of selectable ads is not adjacent to each other, and wherein each selectable ad of said sequence of selectable ads is displayed after a predetermined number of selectable images of said group of selectable images is displayed.

13. The ad displayer of claim 11, further comprising:
an ad fader configured for, while enlarging said selectable ad, fading said group of selectable images, wherein said group of selectable images are in the background of an enlarged selectable ad.

14. The ad displayer of claim 11, wherein said ad display selector comprises:
a display reset timer configured for:
displaying on said display screen a selectable ad after a swipe and a selection of a selectable image is performed on said communication device and a predetermined quantity of said group of said selectable images has passed.

15. The ad displayer of claim 11, wherein each selectable ad of said set of selectable ads is the same size as each other.

16. The ad displayer of claim 11, further comprising:
an ad impression monitor configured for monitoring an ad impression.

17. The ad displayer of claim 11, further comprising:
a clicking monitor configured for monitoring a clicking of a selectable item.

18. The ad displayer of claim 11, further comprising:
a CTR measurer configured for measuring CTR for each selectable ad within said group of selectable images.

19. The ad displayer of claim 18, further comprising:
a CTR positioner configured for positioning each selectable ad within said group of selectable images according to measured CTR.

20. The ad displayer of claim 11, further comprising:
an eCPM positioner configured for positioning each selectable ad within said group of selectable images according to a measured eCPM.
